(19) United States
(12) Patent Application Publication
(10) Pub. No.: US 2002/0002882 A1
(43) Pub. Date: Jan. 10, 2002

(54) Little fingers

(76) Inventor: Lucius Neil Jonett, Chili, WI (US)

Correspondence Address: Lucius Neil Jonett, W641 Cty. Hwy. H, Chili, WI, 54420-9437, US

(21) Appl. No.: 09/732,038

(22) Filed: Dec. 8, 2000

Related U.S. Application Data
(60) Provisional application No. 60/179,090, filed on Jan. 31, 2000.

(51) Int. Cl. B25B 13/00

(52) U.S. Cl. 81/124.2

(57) ABSTRACT

Little Fingers (Co-axial connector tool) is a screw-driver-based design equipped with a slot down the side and a hex head. This tool slides over co-axial cable and to the F-connector. With simple rotation (like a screwdriver), the connector can be tightened or loosened. This tool simplifies the process of attaching and removing co-axial cables, by preventing the wrapping of the cable around the tool and the user's hand.

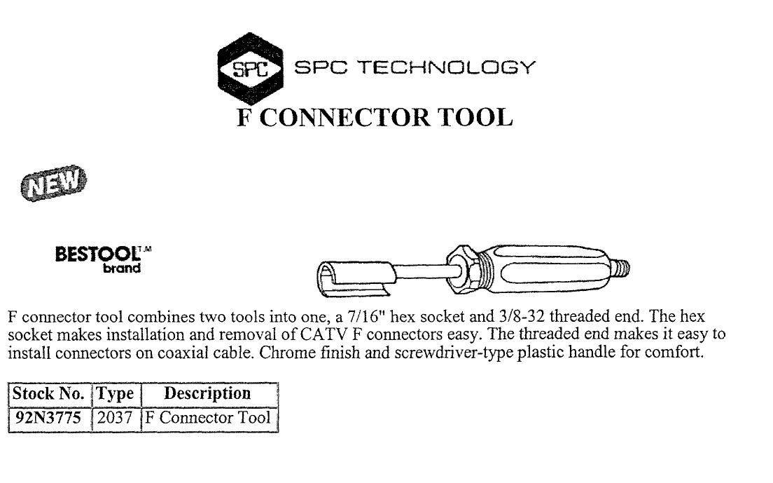

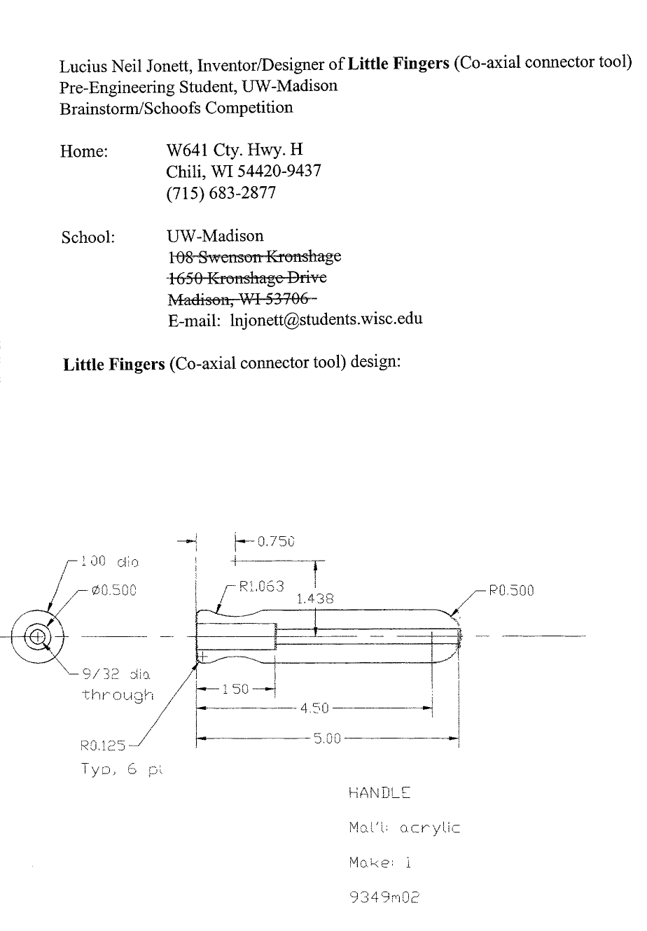

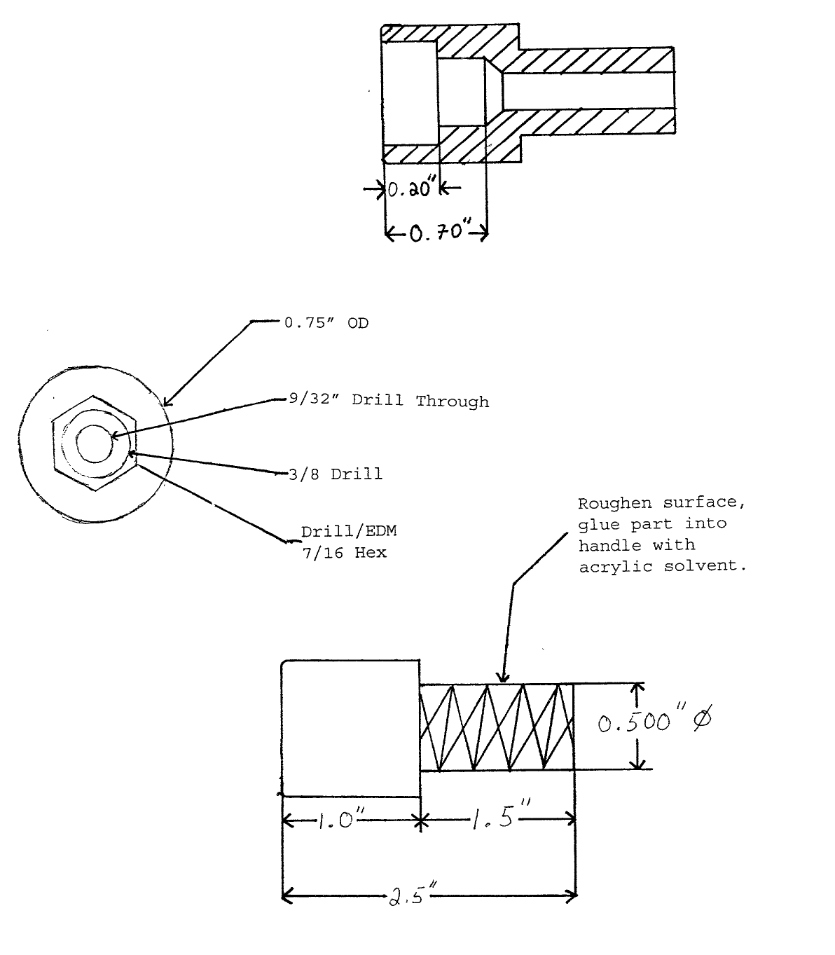

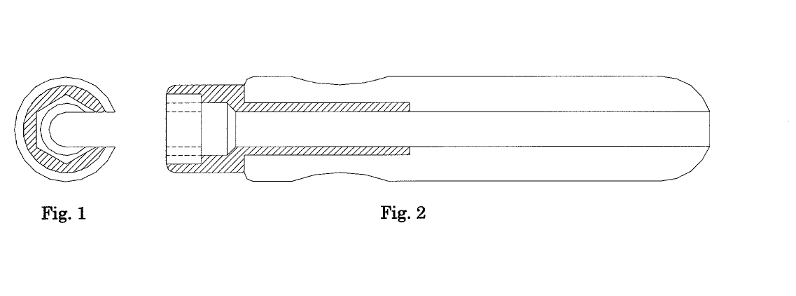

### BACKGROUND/CROSS REFERENCE

Little Fingers (CO-axial connector tool) has a comparable tool. The previous tool is the BESTOOL™ F Connector Tool and retails for about $22.00. My tool is better as the hex head is on the axis of rotation. The BESTOOL design has the hex head off the center of axis. To tighten or loosen the connector, the tool must follow a circular path. My tool doesn't follow a path; it just rotates. Another drawback to the BESTOOL design is that with the hex head is off center as the tool is rotated. The cable will wrap around the tool and the user's hand. With a hole bored down the center of the tool and a slot to the central bore, the cable is place inside the tool on the center of axis. As my tool is rotated, the cable just sits inside the tool and does not wrap around the tool or the user's hand. This makes my tool more efficient. My tool will probably be retailed between $10.00 and $15.00, the cost of a standard screwdriver.

Another fall back of the BESTOOL design is the marketing scheme. As I have been developing my tool, I have not seen another tool that accomplishes my desired task. During development of my second and final prototype, I was made aware of a tool in an industrial catalog. They are not marketing to the entire section of need. My tool will be sold at retail stores, making it available to the entire spectrum of audio/visual equipment users.

### SUMMARY

Little Fingers (CO-axial connector tool) is a screwdriver-shaped tool with a handle made of acrylic and an aluminum insert. The machined aluminum insert has a bored-out center with a slit cut from the central bore to the outside edge. At one end there is hex head milled out with a bowl shape under the hex cutout. This is what catches the F connector and holds it in place. The aluminum insert is then imbedded in the acrylic handle where the slit is continued. This slit allows the cable to be placed inside the tool on the axis of rotation.

1. The novel feature of Little Fingers (CO-axial connector tool) is the idea that the co-axial cable is entirely enclosed by the tool.
